(19) United States
(12) Patent Application Publication
(10) Pub. No.: US 2006/0043329 A1
(43) Pub. Date: Mar. 2, 2006

(54) Piezoelectric ceramic composition

(75) Inventors: Masakazu Hirose, Tokyo (JP); Tomohisa Azuma, Tokyo (JP); Masahito Furukawa, Tokyo (JP); Takeo Tsukada, Tokyo (JP); Norimasa Sakamoto, Tokyo (JP)

Correspondence Address: HOGAN & HARTSON L.L.P., 500 S. GRAND AVENUE, SUITE 1900, LOS ANGELES, CA, 90071-2611, US

(73) Assignee: TDK CORPORATION

(21) Appl. No.: 11/210,468

(22) Filed: Aug. 24, 2005

(30) Foreign Application Priority Data
Aug. 27, 2004 (JP) 2004-247758

(51) Int. Cl. C04B 35/49

(52) U.S. Cl. 252/62.9 PZ; 501/134

(57) ABSTRACT

A piezoelectric ceramic composition which has a large electromechanical coupling factor and is excellent in heat resisting properties is provided. As additives, Cr, Al and Si are contained together in the piezoelectric ceramic composition including a perovskite compound which contains Pb, Zr and Ti as main components. Preferably, Cr, Al and Si are respectively contained in a content of 0.05 to 0.50 wt % in terms of Cr₂O₃, in a content of 0.005 to 1.500 wt % in terms of Al₂O₃, and in a content of 0.005 to 0.100 wt % in terms of SiO₂. By simultaneously including these three elements and setting the contents thereof to fall within the above mentioned ranges, the electromechanical coupling factor kt can be 30% or more, and ΔFr, which is the rate of change in resonant frequency Fr between before and after application of an external thermal shock, can be 0.5% or less in absolute value.

### BACKGROUND OF THE INVENTION

1. Field of the Invention

The present invention relates to a piezoelectric ceramic composition suitable for filters, resonators and the like.

2. Description of the Related Art

Most of the piezoelectric ceramic compositions now being put in practical use are constituted with ferroelectrics having the perovskite structure such as PZT (the PbZrO₃—PbTiO₃ solid solution) based or PT (PbTiO₃) based ferroelectrics having the tetragonal system or the rhombohedral system at around room temperature. These compositions are substituted with third components such as Pb(Mg_{1/3}Nb_{2/3}) O₃ and Pb(Mn_{1/3}Nb_{2/3}) O₃, or various additives are added to these compositions to meet a wide variety of required properties.

The piezoelectric ceramic composition has a capability of freely converting electric energy into mechanical energy or vice versa and extracting the energy, and is used for filters, resonators, actuators, ignition elements, ultrasonic motors and the like.

When the piezoelectric ceramic composition is used, for example, for a filter, it is required that the piezoelectric ceramic composition has a large electromechanical coupling factor.

Accordingly, for example, Patent Document 1 has proposed a piezoelectric ceramic characterized in that in a lead titanate zirconate represented by a general formula aPb(Mg_{1/3}Nb_{2/3})O₃-bPbTiO₃-cPbZrO₃, 0.5 to 5 mol % of the Pb atoms are replaced with Mg atoms and further Cr is added in a content of 0.1 to 1 wt % in terms of Cr₂O₃, wherein a, b and c fall in the ranges of 1≦a≦10, 42≦b≦60 and 30≦c≦57, respectively, in terms of mol % with the proviso that a+b+c=100.

Patent Document 1: Japanese Patent No. 3221241 (claims and Examples)

### SUMMARY OF THE INVENTION

In an example of Patent Document 1, an electromechanical coupling factor (an electromechanical coupling factor Kp for the plane direction vibration) of 30% or more has been obtained at 1 kHz. However, there still persists a demand for a further higher electromechanical coupling factor for further higher frequencies.

In recent years, surface mount devices have come into wide use, and piezoelectric ceramic compositions having high heat resisting properties are demanded because, when parts are mounted on printed circuit boards, the boards are passed through a solder reflow furnace.

The present invention has been achieved for the purpose of solving these technical problems and takes as its object the provision of a piezoelectric ceramic composition which has a large electromechanical coupling factor and is excellent in heat resisting properties.

The present inventors have found that the above described problems can be solved by simultaneously comprising Cr, Al and Si as additives in a piezoelectric ceramic composition comprising a perovskite compound containing Pb, Zr and Ti as main components.

It is preferable that there are contained Cr in a content of 0.05 to 0.50 wt % in terms of Cr₂O₃, Al in a content of 0.005 to 1.500 wt % in terms of Al₂O₃, and Si in a content of 0.005 to 0.100 wt % in terms of SiO₂. By simultaneously comprising these three elements and setting the contents thereof to fall within the above mentioned ranges, the electromechanical coupling factor kt can be made to be 30% or more, and the rate of change ΔFr in the resonant frequency Fr between before and after application of an external thermal shock can be made to be 0.5% or less in absolute value. Hereinafter, the rate of change ΔFr in the resonant frequency Fr will be simply referred to as “ΔFr”. The electromechanical coupling factor kt represents the efficiency of conversion from electric energy into mechanical energy or vice versa in a thickness longitudinal vibration mode, the electromechanical coupling factor being one of basic properties of a piezoelectric material. It may be noted that the electromechanical coupling factor kt and the ΔFr are to be specified by the methods according to the descriptions in the sections, “Best Mode for Carrying Out the Invention” and “Examples,” to be described later.

It is also preferable that the piezoelectric ceramic composition comprises a main component represented by the formula of Pb_{α}[(Mg_{1/3}Nb_{2/3})ₓTi_{y}Zr_{z}]O₃, wherein 0.95≦α≦1.02, 0.01≦x≦0.10, 0.40≦y≦0.50 and 0.45≦z≦0.56, respectively. In this formula, it is preferable that the relation, x+y+z=1, is satisfied.

As described above, according to the present invention, a piezoelectric ceramic composition which has a large electromechanical coupling factor kt and is excellent in heat resisting properties can be obtained.

### BRIEF DESCRIPTION OF THE DRAWINGS

FIG. 1A is a view showing the polarization direction in a case where the vibration mode is a thickness longitudinal vibration, and FIG. 1B is a view illustrating the thickness longitudinal vibration;

FIG. 2 is a perspective view of a specimen with vibrating electrodes formed thereon; and

FIG. 3 is a sectional view along the X-X direction in FIG. 2.

### DETAILED DESCRIPTION OF THE PREFERRED EMBODIMENTS

The piezoelectric ceramic composition according to the present invention will be described below in detail with reference to an embodiment.

<Chemical Composition>

The piezoelectric ceramic composition according to the present invention is characterized by comprising a perovskite compound containing Pb, Zr and Ti as main components and by comprising Cr, Al and Si as additives. The inclusion of all of Cr, Al and Si as additives makes it possible to obtain a piezoelectric ceramic composition which has a large electromechanical coupling factor kt and is excellent in heat resisting properties.

The inclusion of Cr is effective in making the electromechanical coupling factor kt larger and the heat resisting properties higher. On the other hand, Al and Si both contribute to a higher strength.

As for the amounts of the additives in relation to the total amount of the main components, it is desirable that there are set the Cr content at 0.05 to 0.50 wt % in terms of Cr₂O₃, the Al content at 0.005 to 1.500 wt % in terms of Al₂O₃, and the Si content at 0.005 to 0.100 wt % in terms of SiO₂.

When the Cr content is less than 0.05 wt % in terms of Cr₂O₃, the Al content is less than 0.005 wt % in terms of Al₂O₃, and the Si content is less than 0.005 wt % in terms of SiO₂, all in relation to the total amount of the main components, it is impossible to sufficiently enjoy the above described advantageous effects.

On the other hand, when the Cr content exceeds 0.50 wt % in terms of Cr₂O₃, the heat resisting properties are degraded. Also, when the Al content exceeds 1.500 wt % in terms of Al₂O₃, or when the Si content exceeds 0.100 wt % in terms of SiO₂, the heat resisting properties are degraded.

The Cr content ranges more preferably from 0.1 to 0.4 wt % in terms of Cr₂O₃, and still more preferably from 0.1 to 0.3 wt % in terms of Cr₂O₃.

The Al content ranges more preferably from 0.005 to 0.500 wt % in terms of Al₂O₃, and still more preferably from 0.01 to 0.30 wt % in terms of Al₂O₃.

The Si content ranges more preferably from 0.005 to 0.080 wt % in terms of SiO₂, still more preferably from 0.005 to 0.070 wt % in terms of SiO₂, and furthermore preferably from 0.005 to 0.050 wt % in terms of SiO₂.

The present invention characterized by comprising all of Cr, Al and Si as additives can be widely applied to PZT based piezoelectric ceramic compositions, preferably, to piezoelectric ceramic compositions comprising Pb, Zr, Ti, Mg and Nb as main component. In particular, the piezoelectric ceramic composition of the present invention preferably has a main component represented by the following formula (1). The chemical composition as referred to herein means the composition of sintered bodies.
Pb_{α}[(Mg_{1/3}Nb_{2/3})ₓTi_{y}Zr_{z}]O₃ formula (1)
wherein α, x, y and z fall within the ranges of 0.95≦α≦1.02, 0.01≦x≦0.10, 0.40≦y≦0.50 and 0.45≦z≦0.56, respectively, and α, x, y and z each represent a molar ratio.

Next, description will be made below on the reasons for imposing limitations on α, x, y and z in formula (1).

The quantity a representing the Pb content is preferably limited to fall within the range of 0.95≦α≦1.02. When α is less than 0.95, it is difficult to obtain a dense sintered body. On the other hand, when a exceeds 1.02, no satisfactory heat resisting properties can be obtained. Accordingly, α is preferably limited to fall within the range of 0.95≦α≦1.02, more preferably 0.98≦α<1.00, and furthermore preferably 0.99≦α<1.00.

The quantity x representing the Mg content and the Nb content is preferably limited to fall within the range of 0.01≦x≦0.10. When x is less than 0.01, the electric property Qₘₐₓ becomes small. On the other hand, when x exceeds 0.10, no satisfactory heat resisting properties can be obtained. Accordingly, x is preferably limited to fall within the range of 0.01≦x≦0.10, more preferably 0.02≦x≦0.08, and furthermore preferably 0.02≦x≦0.06.

The quantity y representing the Ti content is limited to fall within the range of 0.40≦y≦0.50. When y is less than 0.40, no satisfactory heat resisting properties can be obtained. On the other hand, when y exceeds 0.50, no satisfactory temperature characteristics can be obtained. Accordingly, y is preferably limited to fall within the range of 0.40≦y≦0.50, more preferably 0.41≦y≦0.49, and furthermore preferably 0.42≦y≦0.48.

The quantity z representing the Zr content is limited to fall within the range of 0.45≦z≦0.56. When z is less than 0.45 or exceeds 0.56, no satisfactory temperature characteristics can be obtained. Accordingly, z is preferably limited to fall within the range of 0.45≦z≦0.56, more preferably 0.46≦z≦0.55, and furthermore preferably 0.47≦z≦0.54.

In formula (1), it is preferable that the relation, x+y+z=1, is satisfied.

<Production Method>

Next, a preferable production method of the piezoelectric ceramic composition according to the present invention will be described below by following the relevant steps in order.

(Raw Material Powders and Weighing Out Thereof)

As the raw materials for the main components, there may be used powders of oxides or powders of compounds to be converted to oxides when heated. More specifically, powders of PbO, TiO₂, ZrO₂, MgCO₃, Nb₂O₅ and the like can be used. The raw material powders are weighed out respectively so that the predetermined proportions thereof may be provided. Preferably, the raw material powders are weighed out so that the composition represented by formula (1) may be provided.

Then, in relation to the total weight of these weighed powders, there are added as additives Cr in a range of 0.05 to 0.50 wt % in terms of Cr₂O₃, Al in a range of 0.01 to 1.50 wt % in terms of Al₂O₃, and Si in a range of 0.005 to 0.10 wt % in terms of SiO₂. As the raw material powders for the additives, powders of Cr₂O₃, Al₂O₃ and SiO₂ are provided. The mean particle size of each of the raw material powders may be appropriately set somewhere within the range of 0.1 to 3.0 μm.

In addition to the above described raw material powders, a powder of a composite oxide which contains two or more metals may be used as a raw material powder.

(Calcination)

The raw material powders are subjected to wet mixing and then calcinated while being maintained at a temperature ranging from 700 to 950° C. for a predetermined period of time. This calcination may be conducted under the atmosphere of N₂ or air. The calcination time may be appropriately set within the range from 0.5 to 5 hours.

It has been described above that the raw material powders of the main components and the raw material powders of the additives are mixed together, and then both of them are subjected to calcination. However, the timing for adding the raw material powders of the additives is not limited to the above described timing. As an alternative example, firstly the powders of the main components may be weighed out, mixed, calcined and pulverized; and then, to the main component powder thus obtained after calcination and pulverization, the raw material powders of the additives may be added in respective predetermined amounts to make a mixture.

(Granulation and Compacting)

The pulverized powder is granulated for the purpose of smoothly carrying out a subsequent compacting step. At this time, a small amount of an appropriate binder, for example polyvinyl alcohol (PVA) is added to the pulverized powder, and they are fully mixed, and then a granulated powder is obtained by passing the mixed powder through a mesh of 350 μm for the purpose of sizing the powder particles. Then, the resulting granulated powder is compacted by pressing under a pressure of 200 to 300 MPa to obtain a compacted body having a desired shape.

(Sintering)

After the binder, added at the time of compacting, has been removed from the compacted body, the compacted body is heated and maintained at a temperature within the range from 1100 to 1250° C. for a predetermined period of time to obtain a sintered body. In this sintering, the atmosphere may be N₂ or air, and the compacted body may be heated and maintained appropriately within a range from 0.5 to 4 hours.

(Polarization)

After electrodes for the polarization have been formed on the sintered body, the polarization is carried out. The polarization is conducted under the conditions such that the polarization temperature falls within the range from 50 to 300° C., and an electric field of 1.0 to 2.5 Ec (Ec being the coercive field) is applied to the sintered body for 0.5 to 30 minutes.

When the polarization temperature is lower than 50° C., the Ec is elevated and accordingly the voltage for polarization becomes so high that the polarization is difficult to occur. On the other hand, when the polarization temperature exceeds 300° C., the insulation property of the insulating oil is lowered so markedly that the polarization is difficult to occur. Consequently, the polarization temperature is set to fall within a range from 50 to 300° C. The polarization temperature is preferably 60 to 250° C., and more preferably 80 to 200° C.

When the applied electric field is lower than 1.0 Ec, the polarization does not proceed. On the other hand, when the applied electric field is higher than 2.5 Ec, the actual voltage becomes high, so that the dielectric breakdown of sintered body tends to occur and accordingly it becomes difficult to prepare a piezoelectric ceramic composition. Accordingly, the electric filed to be applied in the polarization is set to be 1.0 to 2.5 Ec. The applied electric field is preferably 1.1 to 2.2 Ec, and more preferably 1.3 to 2.0 Ec.

When the polarization time is less than 0.5 minute, the polarization is not progressed to a sufficient extent, so that the properties cannot be attained to a sufficient extent. On the other hand, when the polarization time exceeds 30 minutes, the time required for the polarization becomes long, so that the production efficiency is degraded. Accordingly, the polarization time is set to be 0.5 to 30 minutes. The polarization time is preferably 0.7 to 20 minutes, and more preferably 0.9 to 15 minutes.

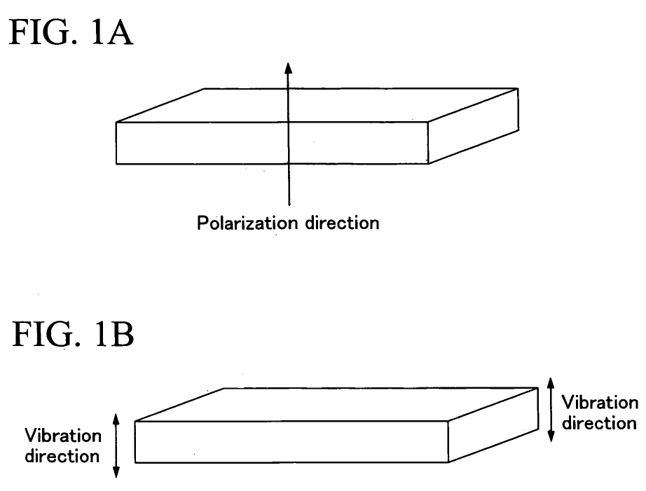

The polarization is conducted in a bath of an insulating oil such as a silicon oil heated to the above described temperature. Incidentally, the polarization direction is determined according to the desired vibration mode. In this connection, when the desired vibration mode is a thickness longitudinal vibration, the polarization direction is taken as shown in FIG. 1(a). Herein, the thickness longitudinal vibration is a vibration along the thickness direction as illustrated in FIG. 1(b).

The piezoelectric ceramic composition is lapped to a desired thickness, and thereafter vibrating electrodes are formed. Then, using a dicing saw or the like, the piezoelectric ceramic composition is cut into a desired shape so as to function as a piezoelectric element.

The piezoelectric ceramic composition of the present invention is suitably used as the materials for the piezoelectric elements for use in filters, resonators, actuators, ignition elements, ultrasonic motors and the like.

By selecting the constituent compositions recommended by the present invention, the electromechanical coupling factor kt can be made to be 30% or more, and further to be 35% or more, and ΔFr can also be made to be 0.5% or less in absolute value, further to be 0.4% or less, and more preferably 0.3% or less. The electromechanical coupling factor kt in the present invention is measured at a measurement frequency of about 10 MHz with an impedance analyzer (HP4194A, manufactured by Hewlett Packard Corp.). The electromechanical coupling factor kt is derived on the basis of the following formula (2):

$$kt = \sqrt{\frac{π}{2} \cdot \frac{Fr}{Fa} cot ( \frac{π}{2} \cdot \frac{Fr}{Fa} )} \qquad formula ( 2 )$$

wherein Fr represents a resonant frequency and Fa represents an anti-resonant frequency.

The ΔFr values in the present invention are measured on the basis of a 24 hour heat resistance test. The 24 hour heat resistance test is conducted by wrapping a piezoelectric ceramic composition specimen with an aluminum foil, immersing the wrap in a solder bath at 250° C. for 30 seconds, then removing the aluminum foil, and allowing the specimen to stand at room temperature for 24 hours. The ΔFr is obtained from the resonant frequency Fr measured before immersing it in the solder bath and that measured after allowing it to stand for 24 hours. It may be noted that in Examples to be described later, the ΔFr values were measured in the same procedures.

### EXAMPLE 1

(Sample No. 1)

As the raw materials, there were prepared the powders of PbO, TiO₂, ZrO₂, MgCO₃, Nb₂O₅, Cr₂O₃, Al₂O₃ and SiO₂; the raw material powders of from PbO to Nb₂O₅ were weighed out in such a way that the molar ratios of the weighed powders satisfy the formula Pb [(Mg_{1/3}Nb_{2/3})_{0.05}Ti_{0.46}Zr_{0.49}]O₃. Thereafter, the powders of Cr₂O₃, SiO₂ and Al₂O₃ were added as additives in contents of 0.2 wt %, 0.05 wt % and 0.03 wt %, respectively, in relation to the total weight of the powders of from PbO to Nb₂O₅. The compounded powders thus obtained were wet-mixed for 10 hours by use of a ball mill.

The slurry thus obtained was dried to a sufficient level, and thereafter calcined in air in a manner maintained at 800° C. for 2 hours. The calcined substance was pulverized with a ball mill so as to have a mean particle size of 0.7 μm, and then the pulverized powder was dried. The dried, pulverized powder was added with PVA (polyvinyl alcohol) as a binder in an appropriate content, and was granulated. The granulated powder was compacted under a pressure of 245 MPa using a uniaxial press machine. The compacted body thus obtained was subjected to the treatment for removing the binder, and thereafter maintained at 1150 to 1250° C. for 2 hours in air to obtain a sintered body (a specimen) having a size of 20 mm in length×20 mm in width×1.0 mm in thickness.

Both surfaces of the specimen were flattened by a lapping machine to obtain a thickness of 0.3 mm, the specimen was then cut into a size of 15 mm in length×15 mm in width by use of a dicing saw, and temporary electrodes (14 mm long×14 mm wide) for polarization were formed on both upper and lower surfaces thereof. Thereafter, the specimen was subjected to a polarization in which the specimen was immersed in a silicon oil bath at a temperature of 120° C., and applied an electric field of 3 kV/mm for 30 minutes. Here, the polarization direction was chosen as shown in FIG. 1(a). Subsequently, the temporary electrodes were removed. Here, the size of the specimen after removing the temporary electrodes was 15 mm in length×15 mm in width×0.3 mm in thickness. The specimen was lapped again by a lapping machine so as for the thickness of the specimen to be 0.22 mm, and then cut into a 7.5 mm long×7.0 mm wide specimen (the specimen 1) by use of a dicing saw.

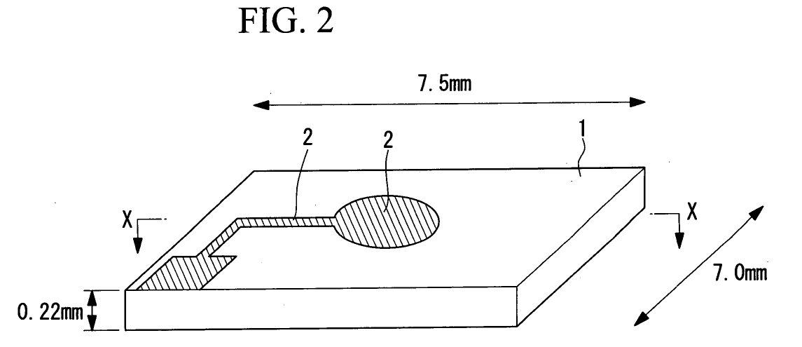

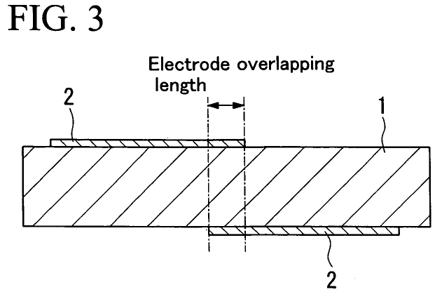

Then, vibrating electrodes 2 were formed on both surfaces (both polished surfaces) of the specimen 1 by using a vacuum evaporation apparatus, as shown in FIG. 2, to yield a sample (Sample No. 1) for measuring the electromechanical coupling factor kt. FIG. 3 shows a sectional view (a sectional view along the X-X direction in FIG. 2) of the specimen 1. The electrode overlapping length for the vibrating electrodes 2 was made to be 1.0 mm. The vibrating electrodes were each formed of a Cr sublayer 0.01 μm thick and an Ag layer 2 μm thick.

(Sample Nos. 2 to 10)

Samples for measuring the electromechanical coupling factor kt was obtained under the same conditions as for Sample No. 1, except that Cr₂O₃ powder, SiO₂ powder and Al₂O₃ powder as additives were respectively added in the amount shown in Table 2.

### COMPARATIVE EXAMPLES 1 to 4

Samples for measuring the electromechanical coupling factor kt was obtained under the same conditions as for Sample No. 1, except that Al₂O₃ powder as an additive was not added, and that Cr₂O₃ powder and SiO₂ powder were respectively added in the amount shown in Table 2.

On the basis of above described formula (2), the electromechanical coupling factors kt of Samples Nos. 1 to 10 and Comparative Examples 1 to 5 were derived. The ΔFr values of Samples Nos. 1 to 10 and Comparative Examples 1 to 4 were also obtained on the basis of the above described method. The results thus obtained are shown in Table 1.

TABLE 1

| | | Cr₂O₃ | SiO₂ | Al₂O₃ | kt | Δ Fr |
|---|---|---|---|---|---|---|
| Sample No. | | [wt %] | [wt %] | [wt %] | [%] | [%] |
| Comparative Example | 1 | 0.2 | 0.05 | 0 | 38.5 | 0.59 |
| | 1 | | | 0.03 | 38.7 | 0.42 |
| | 2 | | | 0.05 | 38.8 | 0.48 |
| Comparative Example | 2 | | 0.01 | 0 | 38.1 | 0.75 |
| | 3 | | | 0.05 | 38.6 | 0.45 |
| | 4 | | 0.03 | 0.01 | 38.5 | 0.45 |
| | 5 | | | 0.03 | 38.4 | 0.45 |
| Comparative Example | 3 | 0.3 | 0.01 | 0 | 39.3 | 0.53 |
| Comparative Example | 4 | | 0.03 | 0 | 38.9 | 0.52 |
| | 6 | | | 0.01 | 39.4 | 0.45 |
| | 7 | | | 0.05 | 38.9 | 0.48 |
| | 8 | | 0.05 | 0.01 | 38.9 | 0.49 |
| | 9 | | | 0.03 | 38.8 | 0.46 |
| | 10 | | | 0.05 | 38.4 | 0.49 |

As shown in Table 1, when Cr₂O₃, SiO₂ and Al₂O₃ were added as additives (Sample Nos. 1 to 10), it was possible to make the absolute value of ΔFr be 0.5% or less, while the electromechanical coupling factor kt of 35% or more was attained.

On the other hand, when only Cr and Si were added as additives (Comparative Examples 1 to 4), a satisfactory electromechanical coupling factor kt was able to be obtained, but the ΔFr value still stayed at a high level.

### EXAMPLE 2

The powder was weighed so as to obtain the composition shown in Table 2 (main component: Pb_{α}[(Mg_{1/3}Nb_{2/3})ₓTi_{y}Zr_{z}]O₃), a piezoelectric ceramic composition was then prepared in the same manner as in Example 1, and the properties were measured in the same manner as in Example 1. The results are shown in Table 2.

TABLE 2

| | Pb_{α}[(Mg⅓Nb⅔)ₓTi_{y}Zr_{z}]O₃ | | | | Cr₂O₃ | SiO₂ | Al₂O₃ | kt | Δ Fr |
|---|---|---|---|---|---|---|---|---|---|
| Sample No. | α | x | y | z | [wt %] | [wt %] | [wt %] | [%] | [%] |
| 11 | 0.98 | 0.04 | 0.48 | 0.48 | 0.2 | 0.05 | 0.03 | 35.3 | 0.45 |
| 12 | 0.98 | 0.09 | 0.42 | 0.49 | | | | 39.6 | 0.47 |
| 13 | 1.00 | 0.04 | 0.44 | 0.52 | | | | 36.4 | 0.40 |
| 14 | 1.00 | 0.05 | 0.49 | 0.46 | | | | 34.0 | 0.34 |
| Comparative Example 5 | 1.00 | 0.05 | 0.46 | 0.49 | 0.2 | 0 | 0.03 | 39.5 | 0.60 |

Although the constitutional elements were fluctuated as shown in Sample Nos. 11 to 14, the absolute value of ΔFr of 0.5% or less, and the electromechanical coupling factor kt of 34% or more were attained.

What is claimed is:

1. A piezoelectric ceramic composition comprising a perovskite compound comprising Pb, Zr and Ti as main components, wherein said piezoelectric ceramic composition comprises Cr, Al and Si as additives.

2. The piezoelectric ceramic composition according to claim 1, wherein:
said piezoelectric ceramic composition comprises, as said additives, Cr in a content of 0.05 to 0.50 wt % in terms of Cr₂O₃, Al in a content of 0.005 to 1.500 wt % in terms of Al₂O₃ and Si in a content of 0.005 to 0.100 wt % in terms of SiO₂.

3. The piezoelectric ceramic composition according to claim 2, wherein:
said piezoelectric ceramic composition comprises Cr in a content of 0.1 to 0.4 wt % in terms of Cr₂O₃.

4. The piezoelectric ceramic composition according to claim 2, wherein:
said piezoelectric ceramic composition comprises Si in a content of 0.005 to 0.080 wt % in terms of SiO₂.

5. The piezoelectric ceramic composition according to claim 2, wherein:
said piezoelectric ceramic composition comprises Al in a content of 0.005 to 0.500 wt % in terms of Al₂O₃.

6. The piezoelectric ceramic composition according to claim 2, wherein:
said piezoelectric ceramic composition comprises Al in a content of 0.01 to 0.30 wt % in terms of Al₂O₃.

7. The piezoelectric ceramic composition according to claim 1, wherein:
said piezoelectric ceramic composition further comprises Mg and Nb as main components.

8. The piezoelectric ceramic composition according to claim 7, comprising the main component represented by the formula of Pb_{α}[(Mg_{1/3}Nb_{2/3})ₓTi_{y}Zr_{z}]O₃, wherein α, x, y and z fall within the ranges: 0.95≦α≦1.02, 0.01≦x≦0.10, 0.40≦y≦0.50 and 0.45≦z≦0.56, respectively.

9. The piezoelectric ceramic composition according to claim 8, wherein:
said piezoelectric ceramic composition comprises, as said additives, Cr in a content of 0.1 to 0.4 wt % in terms of Cr₂O₃, Al in a content of 0.005 to 0.080 wt % in terms of Al₂O₃ and Si in a content of 0.005 to 0.080 wt % in terms of SiO₂.

10. The piezoelectric ceramic composition according to claim 8, wherein:
said α falls within the range: 0.98≦α<1.00.

11. The piezoelectric ceramic composition according to claim 8, wherein:
said x falls within the range: 0.02≦x≦0.08.

12. The piezoelectric ceramic composition according to claim 8, wherein:
said y falls within the range: 0.41≦y≦0.49.

13. The piezoelectric ceramic composition according to claim 8, wherein:
said z falls within the range: 0.46≦z≦0.55.

14. The piezoelectric ceramic composition according to claim 8, wherein:
the relation, x+y+z=1, is satisfied.

15. The piezoelectric ceramic composition according to claims 1 or 2, wherein:
the electromechanical coupling factor kt thereof is 30% or more at a measurement frequency of 10 MHz.

16. The piezoelectric ceramic composition according to claims 1 or 2, wherein:
the electromechanical coupling factor kt is 35% or more at a measurement frequency of 10 MHz.

17. The piezoelectric ceramic composition according to claims 1 or 2, wherein:
ΔFr, which is the rate of change in resonant frequency Fr between before and after application of an external thermal shock, is 0.5% or less in absolute value.
